(19) United States
(12) Patent Application Publication
(10) Pub. No.: US 2012/0196011 A1
(43) Pub. Date: Aug. 2, 2012

(54) METHOD AND APPARATUS FOR SURFACE SANITIZING OF FOOD PRODUCTS IN A COOKING APPLIANCE USING ULTRAVIOLET LIGHT

(76) Inventor: Perry D. Felix, Houston, TX (US)

(21) Appl. No.: 13/389,279

(22) PCT Filed: Aug. 6, 2010
(86) PCT No.: PCT/US2010/044715

§ 371 Date: Apr. 20, 2012

Related U.S. Application Data
(60) Provisional application No. 61/232,206, filed on Aug. 7, 2009.
(60) Provisional application No. 61/233,389, filed on Aug. 12, 2009.

(51) Int. Cl. A23B 4/015; A23L 3/28

(52) U.S. Cl. 426/243; 99/451

(57) ABSTRACT

The present invention provides a method and apparatus for sanitizing consumable products, utensils or any of a variety of products that may benefit from being sanitized using an ultraviolet light source within a cooking appliance, such as a microwave oven. The cooking appliance includes a cooking chamber capable of receiving microwave energy. A UV light source is positioned outside the cooking chamber, and an optical system directs UV light from the UV light source into the cooking chamber.

### BACKGROUND OF THE INVENTION

1. Field of the Invention

This invention relates generally to sanitizing consumable products, and, more particularly, to sanitizing consumable products using an ultraviolet (UV) laser in a cooking appliance.

2. Description of the Related Art

In the course of day-to-day living, people come into contact with numerous products that have been handled or prepared in such a way that these products may have been exposed to germs, bacteria, viruses, molds, fungi, insect larvae or other undesirable and unsanitary conditions. In the course of consuming or even using these products, a person may become infected or otherwise made ill. For example, food products, such as meat, poultry, fish, cereal, water, etc., may be inadvertently exposed to contaminated conditions.

The food industry has attempted to limit the instances of contamination by reducing the likely sources of contamination. For example, frequent cleansing of food processing equipment with sanitizing or disinfecting agents may help to limit or reduce instances of contamination. However, even an occasional failure of the cleansing process can produce widespread contamination, as evidenced by infrequent reports of food product contamination and subsequent recalls. These instances are dangerous to the public, expensive to remedy, and damaging to the reputation of the offending company. Moreover, the sanitizing agents are often ineffective and are environmentally harmful to produce, store and dispose of. Consumer food products are also processed with various chemicals including fungicides and pesticides which are not earth, ozone & environmentally friendly (i.e., not green). Further, sanitizing and/or disinfecting agents are expensive, and may cause illness in the consumer and/or work force if used improperly.

Consumers are commonly cautioned to take extra care during food preparation to prevent initial contamination of food products and/or to prevent spreading contamination to unaffected food products. One method that is commonly suggested to consumers is to thoroughly cook food products, as high heat levels are known to kill many of the more common contaminants. Unfortunately, high heat levels can resort in food products that are over-cooked, and thus, less palatable. Moreover, consumers often use microwave type ovens to heat food products to a temperature that is suited to their taste, but insufficient to adequately destroy contaminants. Further, as food products are heated in a microwave oven, they sometimes spill or splatter onto the interior surface of the oven. These spilled or splattered food items may also become contaminated, and thus, any future items placed in the microwave oven may likewise become infected.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for sanitizing a consumable product by exposing the product to ultraviolet light within a cooking appliance.

In another embodiment, a cooking appliance includes a cooking chamber capable of receiving microwave energy. A UV light source is positioned outside the cooking chamber. An optical system directs UV light from the UV light source into the cooking chamber.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrate various embodiments of the instant invention;

FIGS. 2A-2J illustrate various mountings of an ultraviolet light source and optical systems for transmitting the ultraviolet light into a cooking chamber of an appliance;

FIG. 3 illustrates a system that may be used to introduce ultraviolet light at various locations of an appliance;

FIGS. 4A-4C illustrate alternative embodiments of a system that may be used to introduce ultraviolet light at various locations of an appliance;

FIGS. 5A-5B conceptually illustrate flow chart diagrams of control strategies that may be employed in various embodiments of the instant invention;

FIGS. 6A-6C illustrate an alternative embodiment regarding the structure and method for transmitting ultraviolet light into an appliance;

FIGS. 7A and 7B illustrate alternative embodiments for transmitting ultraviolet light within an appliance; and

FIGS. 8A-8B illustrate alternative embodiments for transmitting ultraviolet light within an appliance.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

FIG. 1 conceptually illustrates a first exemplary embodiment of the instant invention. Generally, an appliance 10, such as a microwave oven, toaster oven, conventional gas/electric oven, convection oven, and the like, is provided to cook certain food products within a cooking chamber 12. A sanitizing system 14 is positioned adjacent the chamber 12 and includes an optical system 16 that directs ultraviolet (UV) laser light from a UV laser 18 into the chamber 12. In some embodiments of the instant invention, it may be useful to provide an exterior housing (not shown) that encloses the sanitizing system 14 and/or the UV laser 18. The optical system 16 directs the UV laser light along a fixed or movable path to bathe at least a substantial portion of the chamber 12 with UV laser light so as to sanitize the chamber 12 and any food product present therein. In some embodiments of the instant invention, it may be useful to enclose the chamber 12 with a moveable door (not shown) that includes a glass portion for viewing items placed in the chamber 12. Additionally, it may also be useful to construct the glass portion for UV protective safety glass to reduce the likelihood that UV light waves may pass therethrough.

Numerous embodiments of the optical system 16 are envisioned. For example, the optical system 16 may be comprised of fiber optic cables, expansion lenses, fixed and/or rotating mirrors and the like, arranged to route the laser light from the UV laser 18 into the chamber 12. In the exemplary embodiment of FIG. 1, the UV laser 18 is positioned outside the cooking chamber 12, and the optical system 16 includes a mirror 20 for redirecting the laser light through an opening 22 in a top wall 22 of the cooking chamber 12. An expansion lens 24 alters the shape of the laser light from a substantially collimated beam produced by the laser 18 to a conical shape (diagrammatically shown as element 26). The cone shaped UV light impinges upon a substantial portion of the cooking chamber 12, such as at about the middle of the cooking chamber 12 so as to substantially irradiate the food item with sanitizing UV laser light. In some embodiments of the appliance 10, it may be useful to construct the interior walls 28 of a material that will reflect a substantial portion of the UV laser light, so that the laser light impinging on the interior walls 28 of the cooking chamber will be reflected at a variety of angles so as to illuminate additional areas of the cooking chamber 12 and thereby enhance the sanitizing effect of the UV laser light.

Those skilled in the art will appreciate that the optical system 16 may take on any of a variety of forms. For example, the optics system 16 may be tapped into the top wall 22 of the cooking chamber 20. The optics system 16 may be constructed to support a variety of lens sizes based on requirements of laser energy density or distribution for cooking chamber size and type. The lens may be constructed of high temperature glass, crystal, polymer, mineral, resin or plastic, and may have dielectric coatings.

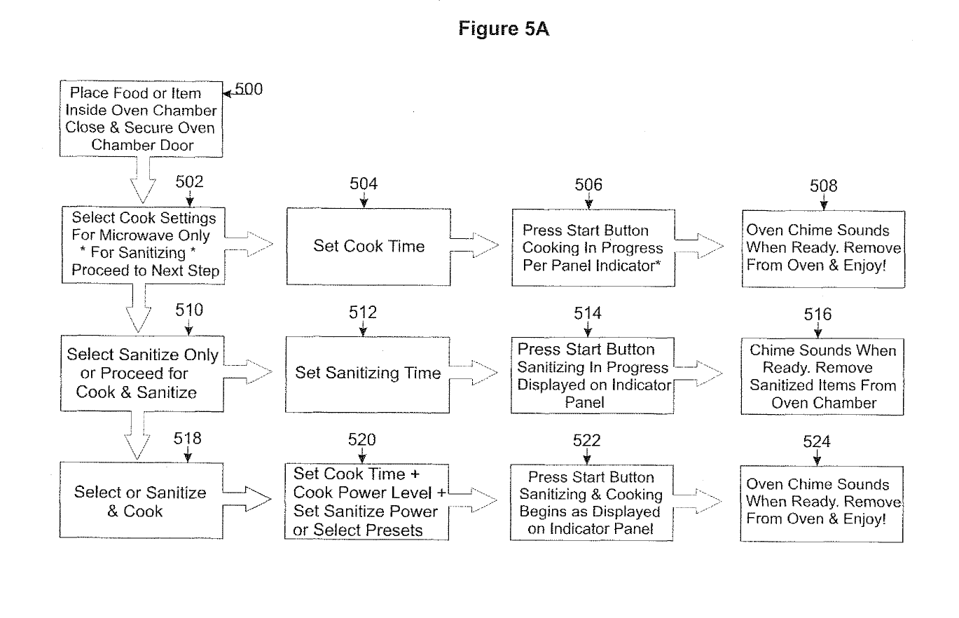

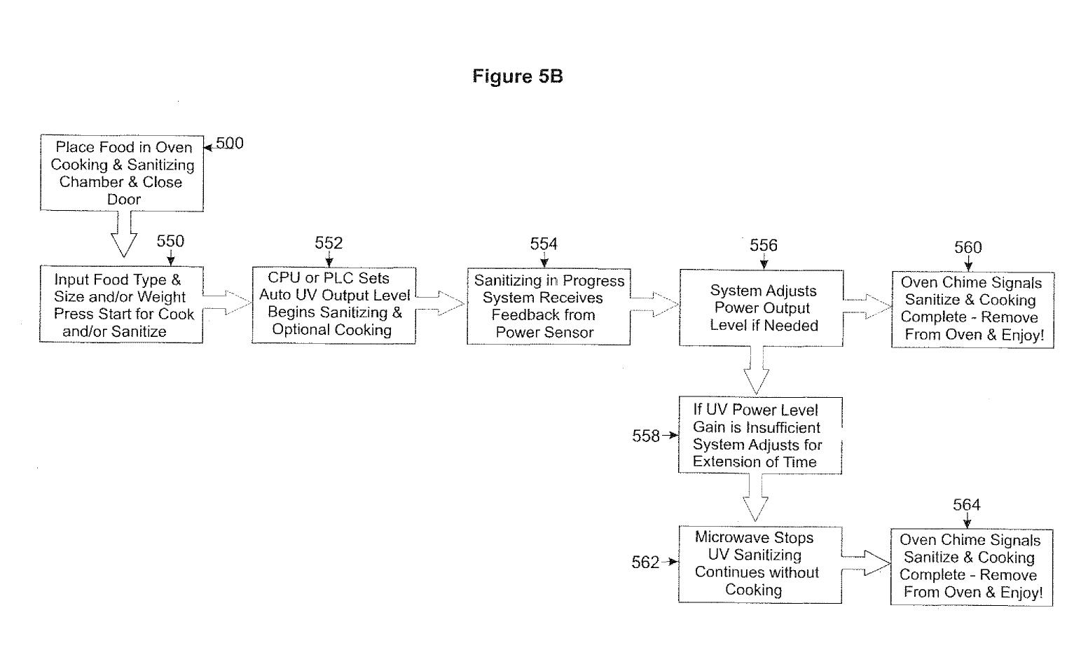

The UV laser 16 operates under the control of a computer control system 30. The appliance 10 may also be equipped with a computer control system 32 for operating the various functions of the appliance 10, such as heating, cooking, timing, etc. The computer control systems 30 may take on any of a variety of forms, including but not limited to microprocessors, microcontrollers, programmable logic controllers, etc. Moreover, those skilled in the art will appreciate that the functionality of the two control systems 30, 32 may advantageously be combined into a single control system capable of effecting control of both aspects (e.g., cooking and sanitizing) of the appliance 10. The operation of the computer control system 30 is discussed in greater detail below in conjunction with the flowcharts of FIGS. 5A and 5B.

The UV laser 18 may take on any of a variety of forms, including pulsed and continuous beam, but generally, a common wavelength for the UV laser 18, when used in a sanitizing application, is in the range of about 90 nm to about 400 nm, which those skilled in the art will appreciate includes near UV wavelengths of about 220 nm to about 400 nm, far UV wavelengths of about 190 nm to about 220 nm, and VAC UV wavelengths of about 90 nm to about 190 nm. Depending on the size of the cooking chamber 12, area of coverage and type of product, the power of the UV laser 18 may range from as little as 2 mW to hundreds or even thousands of watts UV laser power. In one exemplary embodiment of the instant invention, a UV laser 18 operating at about 355 nm wavelength proved to be highly effective in sanitizing food products, achieving an effective rate as high as 99.7% for killing bacteria, viruses, mold, fungi and insect larvae. In one particular embodiment, the UV laser may take the form of a solid state fiber laser, such as Han's Laser Model No. F266 or Model No. F355 or laser diode pumped solid state laser, such as Model No. DP355 available from Han's Laser or a direct diode laser such as Model No. DD355, also available from Han's Laser.

The laser light may be distributed over a substantial portion of the cooking chamber 12 using a variety of mechanical and/or optical systems. For example, a rotating or oscillating mirror may be used to reflect the laser light into the cooking chamber 12 to create a pattern of light that effectively exposes the food product therein to the laser light regardless of the location of the food product within the cooking chamber 12. FIG. 1 illustrates the laser light being distributed in a conical pattern for illustrative purposes only. Those skilled in the art will appreciate that the laser light could be distributed in a variety of patterns, such as square, rectangular, linear, raster scan or even random patterns in order to effectively expose the food product to the laser light.

In one embodiment of the instant invention, the computer control system 30 operates to control various parameters of the system 10 to insure an effective kill rate. For example, a laser power sensor 34 may be disposed to sense actual laser power being delivered to the food product. The sensor 34 may be disposed in the chamber 12 or may be external thereto, but still exposed to the actual laser light, such as in the optical system 16. The laser power sensor 34 provides feedback to the computer control system 30. The computer control system 30 may then vary a signal delivered to the laser 18 to raise or lower the power of the UV laser 18, as desired.

In some embodiments of the instant invention, it may be useful to sanitize only the surface of the food product. However, in other embodiments of the instant invention it may be useful to also provide subsurface sanitization of certain food products. Subsurface sanitizing may be effected by controlling the energy density of the UV laser light being delivered to the food product. For example, by increasing the power of the laser light source, the UV laser light may penetrate the food product to a desired depth and thereby sanitize not only the surface, but the penetrated depth as well. The power of the laser light source may be increased or controlled to provide a desired level of subsurface sanitization by controlling the power of the light source itself, or by focusing the beam of light to a greater or lesser extent, as desired. Further, those skilled in the art will appreciate that the density of the food product will have a significant affect on the depth of the subsurface sanitization. For example, a dense food product, such as steak may require a greater level of energy to effect significant subsurface sanitization, whereas a substantially less dense food product, such as flour, may be sanitized to a substantially greater depth using substantially less energy. Subsurface sanitization may be useful to destroy undesirable infestations, such as insect larvae in flour.

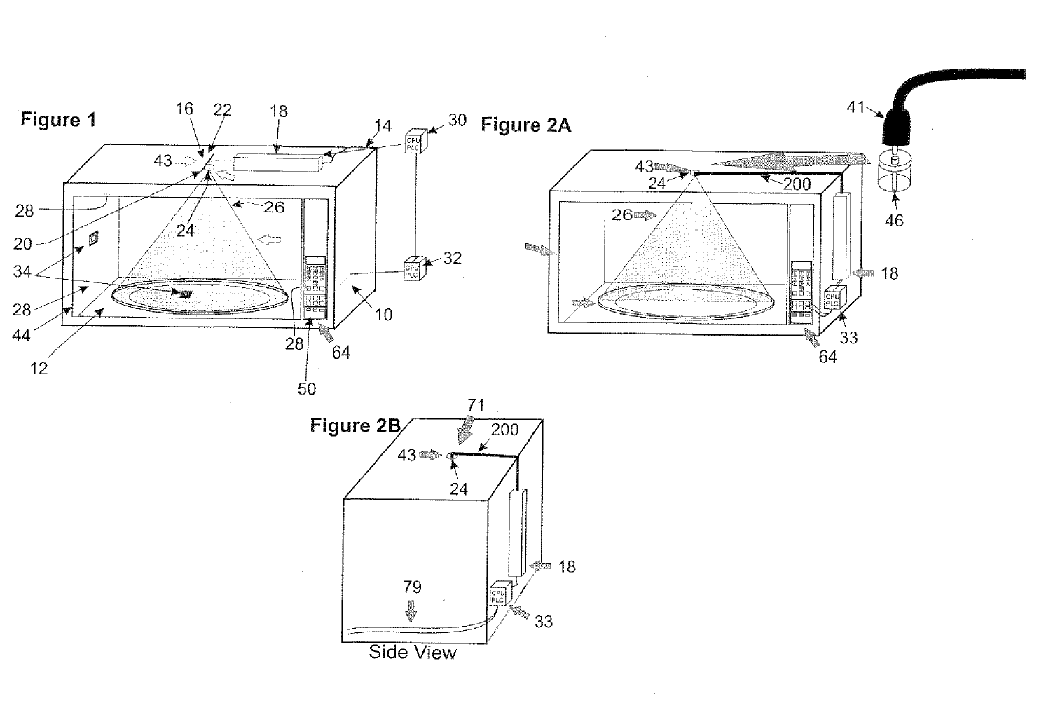

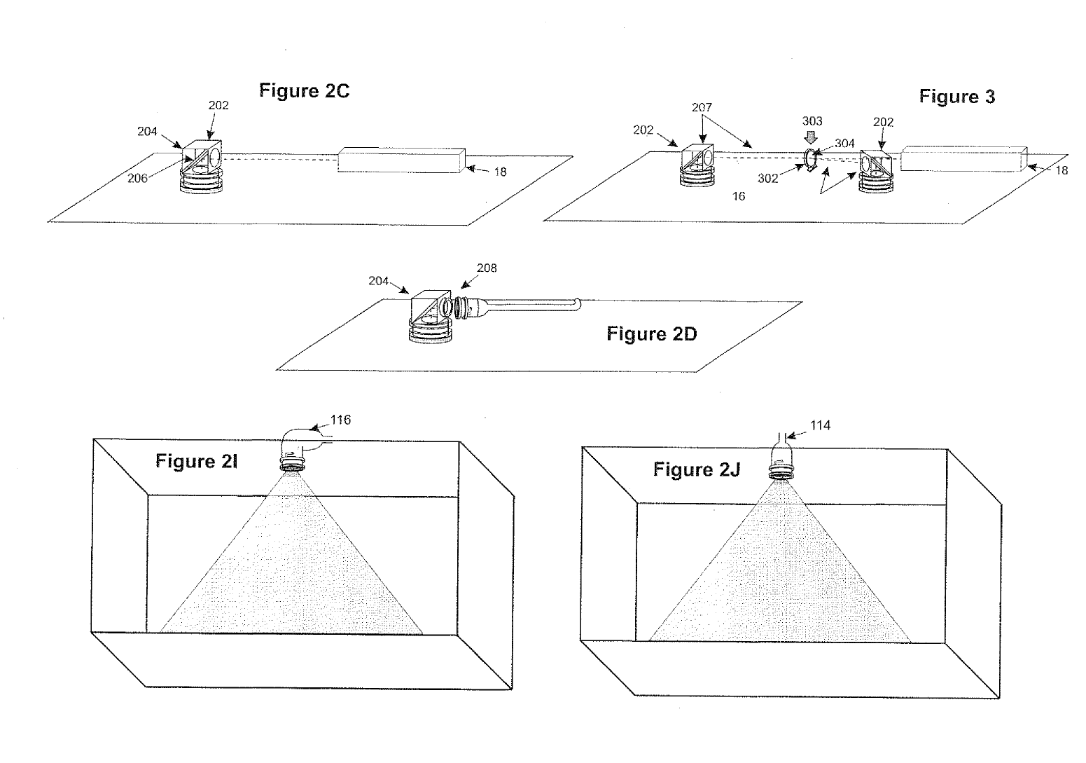

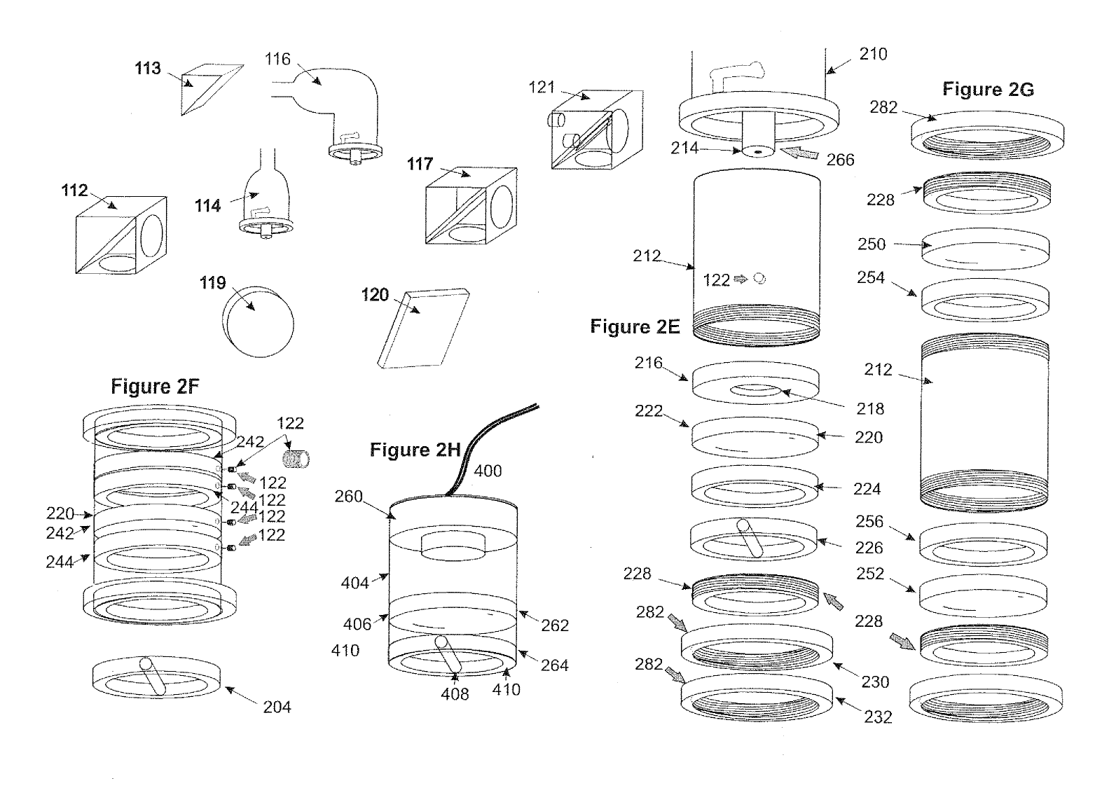

FIGS. 2A and 2B illustrate alternative locations for the laser 18, as well as an alternative optical system 16 that employs a fiber optic delivery system. For example, it is anticipated that the laser may be remotely located from the opening 24, such as on the back of the oven (FIG. 2B) or mounted on the side of the oven (FIG. 2A). In these exemplary embodiments it may be useful to deliver the laser light from the remote laser to the opening 24 via a fiber optic system 200.

Both the fiber optic system 200 and the optic system 16 may include an optics cylinder mount 202, which is generally illustrated in FIGS. 2C-2D and generally includes a cube mount 204 with a mirror or prism angularly mounted therein (e.g., 45°) so as to redirect the UV laser light into the cooking chamber 12. One or more lenses may be disposed in the optics cylinder mount 202 to allow the UV laser light to be focused or otherwise shaped to better illuminate the cooking chamber 12. As shown in FIG. 2D, in an embodiment of the instant invention that employs fiber optics, it may be useful to provide a fiber optic connector 208 on a port of the cube mount 204.

One embodiment of the optics cylinder mount 202 that may be employed in the fiber optic system 200 is illustrated in an exploded view of FIG. 2E. A fiber optic cable ferrule 210 may be coupled to a tube 212, which is configured to pass through the top wall 22 of the cooking chamber 12. The Ferrule 210 includes a fiber optic cable pin 214 that extends coaxially into the rube 212. A fiber optic pin guide 216 has a diameter substantially similar to the inner diameter of the tube 212 so that the guide 216 may be inserted into the tube proximate an end portion of the tube 212. The guide has a substantially coaxial opening sized and positioned to receive the fiber optic cable pin 24 when the ferrule 210 is coupled to the tube 212. In this manner, the fiber optic pin guide 216 acts to position and orient the fiber optic cable pin 214 relative to the tube 212.

An optical assembly 220 is disposed in the tube 212 adjacent the fiber optic pin guide 216. The optical assembly 220 includes a lens 222, a spacer 224 and a line lens 226. The optical assembly 220 is held in a desired longitudinal position within the tube 212 by a threaded retainer ring 228. The interior bore of the tube 212 is threaded to receive the threaded retainer ring 228 therein. The exterior surface of the tube 212 is also threaded to receive a pair of upper and lower flange rings 230, 232. The flange rings 230, 232 are respectively positioned above and below the top wall 22 of the cooking chamber 12 so as to capture the tube 212 in a substantially fixed relationship with the top wall 22 of the cooking chamber 12.

UV laser light exits from the fiber optic cable pin 214 and passes through the lens 222 where it is focused onto the line lens 226. The line lens 226 reshapes the laser light into a line format and then passes the reshaped laser light into the cooking chamber 12 where it impinges upon the food products and interior walls of the cooking chamber 12 to sanitize the region. The cooking chamber 12 may be equipped with a conventional rotating mechanism that causes the food product placed thereon to rotate beneath the line format laser light projected from the line lens 226. Thus, as the food item rotates under the line lens, substantially all regions of the food product are sanitized by exposure to the UV laser light.

FIG. 2F illustrates an alternative arrangement of the tube 212 and optical system 220 in which the position of the various optical components within the tube 212 are held in desired positions and orientations relative to the tube and one another by set screw 240 extending axially through the tube 212 to engage an outer surface of various lenses 242, spacers 244 and the like located interior to the tube 212.

An alternative arrangement of the tube 212 and optical system 220 is shown in FIG. 2G. In this embodiment, the optical system is comprised of a pair of lenses 250, 252 positioned within the tube 212 and separated by one or more spacers 254, 256. The lenses 250, 252 allow for a desired focusing and shaping of the laser light introduced therein. In this embodiment, the line lens 226 is not employed.

FIG. 2H illustrates an alternative embodiment of the optical system 22 that includes a local laser, such as a diode laser 260. The diode laser 260 is positioned within the tube 212 along with the optics system 220. In this embodiment, the optics system 220 includes a lens 262, a line lens 264, and any necessary spacers (not shown). UV laser light exits from the diode laser 260 and passes through the lens 262 where it is focused onto the line lens 264. The line lens 264 reshapes the laser light into a line format and then passes the reshaped laser light into the cooking chamber 12 where it impinges upon the food products and interior walls of the cooking chamber 12 to sanitize the region.

It may be useful to use a single laser and project the laser light into the chamber 12 at a plurality of locations. For example, the embodiment illustrated in FIG. 3 includes first and second openings 24a, 24b and an optical system that is configured to split the laser light into separate paths so that laser light is delivered from multiple locations to provide enhanced coverage of food products within the chamber 12. In one embodiment, the optical system 16 includes a beam splitter that directs approximately one-half of the laser light into the opening 24a while the remaining light is passed to the second opening 24b. FIG. 3 conceptually illustrates one embodiment of an optical system capable of delivering UV laser light to both openings 24a, 24b. For example, the UV laser 18 is arranged to deliver laser light to a 50/50 beam splitter 304 that is contained in a tilt and swivel mount 304. The beam splitter 304 directs about 50% of the laser light to a first optics cylinder mount 202 and the remaining laser light to a second optics cylinder mount 202. As discussed above, the optics cylinder mount 202 can take on a variety of forms that each deliver the laser light into the cooking chamber 12.

It is anticipated that the laser 18 may be positioned in alternative locations. For example, it is anticipated that the laser may be remotely located from the openings 24a, 24b, such as on the side of the oven (as shown in FIG. 2A) or mounted on the back of the oven (as shown in FIG. 2B). In these exemplary embodiments it may be useful to deliver the laser light from the remote laser 18 to the openings 24a, 24b via a fiber optic system. In one embodiment, the fiber optic system may be comprised of a fiber optic coupler to split the laser light into separate beams for delivery to the openings 24a, 24b. The openings 24a, 24b may be configured with the ceramic or glass ring 302 and the high temperature glass or crystal lens 304. It is also envisioned that both right angle and straight line fiber optic cable connectors (see, 114, 116 in FIGS. 21 and 2J) may be employed to deliver the laser light through the openings 24a and 24b.

Alternatively, it is anticipated that some embodiments of the invention may utilize a plurality of UV lasers 18. Moreover, when multiple UV lasers 18 are employed, they may be selected to have substantially similar or substantially different wavelengths and may be arranged in a variety of physical configurations, such as an array. The multiple UV lasers may be configured to have their output combined through prisms, fiber optic couplers, beam combiners, or the like. In some embodiments, it may be useful to provide two or more lasers irradiating the food product in the cooking chamber 12 at substantially the same location with substantially similar wavelengths to achieve higher power levels. Alternatively, in some embodiments, it may be useful to provide two or more lasers irradiating the food product 12 at different, partially overlapping locations to achieve greater surface coverage. Further, some embodiments of the instant invention may utilize two or more UV lasers 18 that operate at different wavelengths to expose the food product to a wider range of UV laser light in cases where the various contaminants are eradicated more effectively by different frequencies of UV laser light. It is envisioned that the multiple UV lasers may be arranged in an array.

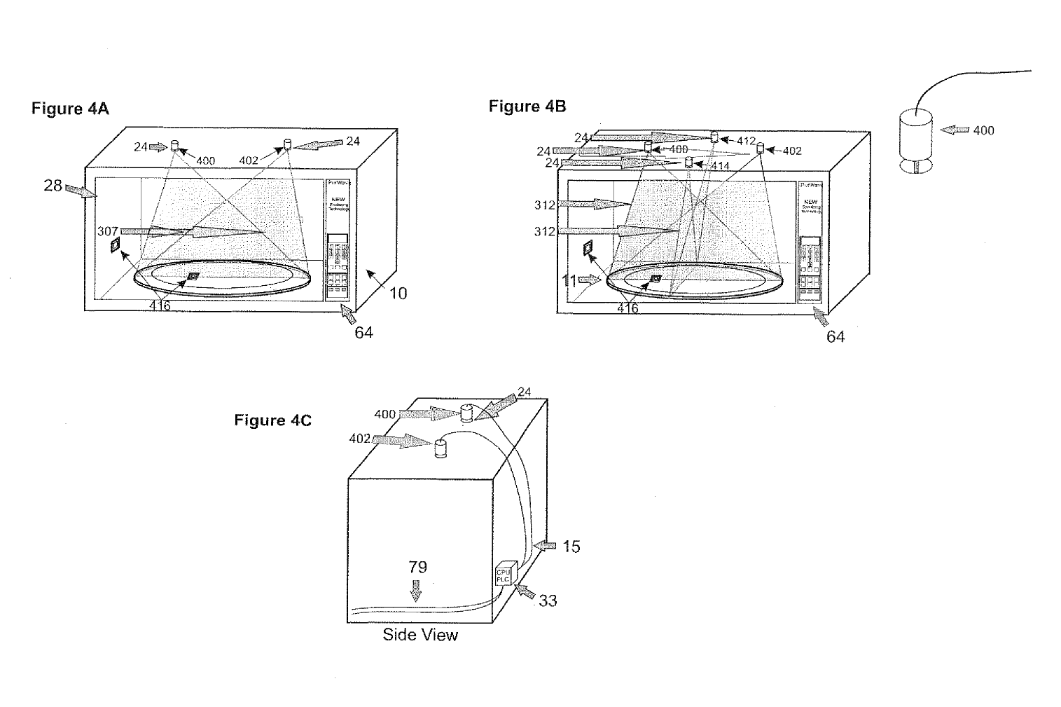

Embodiments of a multiple laser system are illustratively shown in FIGS. 4A-4C. For example, FIG. 4A illustrates a microwave oven having two laser modules 400, 402 located on the top of the microwave 10 and each arranged to transmit an expanded beam of UV laser light into the chamber 12 in an overlapping pattern. The laser modules 400, 402 may be substantially similar and are shown in more detail in FIG. 4B. One embodiment of the laser modules 400, 402 is shown and discussed above in conjunction with FIG. 2H.

FIG. 4B illustrates an alternative embodiment in which four UV laser modules 400, 402, 412, 414 are arranged in an array to provide enhanced coverage of food products placed in the chamber 12. It will be appreciated by those skilled in the art that the multiple UV laser modules 400, 402, 412, 414 may be controlled by the controller 30 operating under software or hardware control. Further, it is anticipated that one or more power sensors 416 may be located in the chamber 12 to provide feedback to the controller 30 regarding the overall operation of the UV laser modules 400, 402, 412, 414. In the case where different wavelength UV laser modules are utilized, a plurality of power sensors 416 that are sensitive to the different wavelengths employed may be useful to provide feedback regarding the operation of individual laser modules 400, 402, 412, 414.

An exemplary embodiment of a control sequence that may be implemented, at least partially, within the computer control system 30 is shown in FIG. 5A. The process begins at block 500 with the a food item being placed in the oven 10 and the door closed in preparation of cooking, heating and/or sanitizing a food product. At block 502, the computer control system 30 monitors a keyboard entry device to determine if a user selects to cook the food item. If so, control transfers to block 504 where the cook time (and other cooking parameters) is selected. At block 506, the user selects the start button and the computer system 30 begins the cooking process by, for example, selecting or establishing a desired amount of power to be provided by the microwave generator (not shown). The computer control system 30 may control the microwave generator of the oven to heat the food product according to instructions entered by the user so that the food product is heated properly. When the heating process is complete, control transfers to block 508 where the process terminates.

Alternatively, at block 510, the user may elect to sanitize the food product without heating or cooking at that time. At block 512, the sanitizing time is selected by the user. At block 514, the user selects the start button and the computer system 30 begins sanitizing process by, for example, selecting or establishing a desired amount of power to be provided by the UV laser 18. The UV laser 18 is enabled, and various parameters of the UV laser 18 are adjusted, either manually, or by the computer control system 30 to provide the desired level of power from the laser 18. For example, it may be useful to set the laser and optics focus adjust, aperture beam alignment, and divergence. The computer control system 30 may also set a power output control and irradiance monitor for the UV laser 18. In one embodiment of the instant invention, the irradiance monitor is the light energy sensor 34. The irradiance monitor gathers light to monitor and report light energy exposure digitally, which can be used to determine the correct balance of laser energy or to regulate output power of UV laser 18. Periodically, the computer control system 30 will receive a control signal from the laser power sensor 34, and use that signal to adjust various parameters of the UV laser 18 to achieve the desired sanitization of the food product. For example, the computer control system 30 may set or adjust a pulse width, a repetition rate, and/or tune the frequency wavelength of the UV laser 18 based on information received from the power sensor 34. These parameters may be adjusted as necessary to maintain a desired level of UV laser power within the chamber 12. When the sanitizing process is complete, control transfers to block 516 where the process terminates.

Additionally, at block 518, the user may elect to sanitize and cook the food product at the same time. At block 520, the sanitizing time, cook time and cook power level may be selected by the user. At block 522, the user selects the start button and the computer system 30 begins sanitizing and cooking processes described above either serially or in parallel. When the cooking and sanitizing processes are complete, control transfers to block 524 where the process terminates.

It is anticipated that different levels of UV laser power may be needed to sterilize different types of food. The microwave oven 10 includes a user interface 50 through which a user may enter data regarding the food product he/she wishes to sterilize and cook. For example, the user may enter time and power level. Alternatively, the user may be queried to enter type of food and weight, such as chicken, 2 pounds. This information regarding the cooking time and level, food type and weight may be used to adjust the period of time over which the UV laser 18 is energized and/or the power level of the UV laser 18. An exemplary flow chart describing the operation of the computer control system 30 to vary sterilization is illustrated in FIG. 5B.

The process begins at block 550 with the computer control system 30 querying the user to enter information regarding the food product. At block 552, the computer control system 30 establishes a desired power level and period of time for energizing the UV laser 18 based, at least in part, on the information entered by the user regarding the food product. At block 554, the computer control system 30 receives feedback information from the power sensor 34. At block 556, the control system adjusts the power of the UV laser 18, if needed, based on information from the power sensor 34. At block 558, in the event that the desired power level cannot be reached, then the computer control system 30 may elect to extend the time period over which the UV laser 18 is energized. The process continues until the desired time period elapses. At that time, the UV laser or LEDs 18 are turned off and if the cooking time has also elapsed, then the microwave oven 10 signals that the food product is ready.

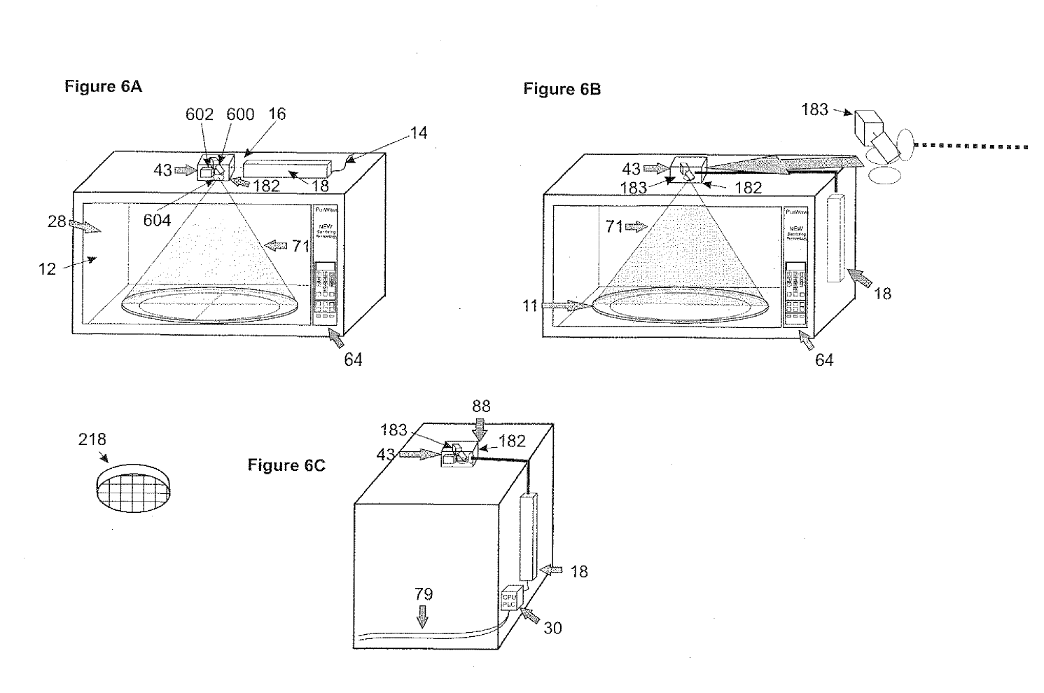

FIGS. 6A-6C generally illustrate an alternative embodiment of the instant invention in which the sanitizing system 14 is positioned adjacent the chamber 12 and includes the optical system 16 that directs ultraviolet (UV) laser light from a UV laser 18 into the chamber 12. In the illustrated embodiment, the optical system 16 is comprised of a mirror or lens 600 arranged to oscillate or rotate so as to reflect or refract the laser light and cause it to traverse a linear path within the chamber 12. In the exemplary embodiment of FIG. 6A, the UV laser 18 is positioned outside the cooking chamber 12, and the optical system 16 includes the mirror or lens 600 coupled to a galvanometer 602 with other optics, such as a collimating lens 604. Laser light reflected or refracted from the mirror or lens 600 is passed through the collimating lens and directed into the chamber 12 through an opening 24 in the top wall 22. In an alternative embodiment, the galvanometer 602 may be configured to provide oscillating or rotating movement along two axis so that light reflected or refracted by the mirror or lens 600 may be introduced into the chamber in a substantially conical configuration. The cone shaped UV light impinges upon a substantial portion of the cooking chamber 12, such as at about the middle of the cooking chamber 12 so as to substantially irradiate the food item with sanitizing UV laser light. In some embodiments of the appliance 10, it may be useful to construct the interior walls 28 of a material that will reflect a substantial portion of the UV laser light, so that the laser light impinging on the interior walls 28 of the cooking chamber 12 will be reflected at a variety of angles so as to illuminate additional areas of the cooking chamber 12 and thereby enhance the sanitizing effect of the UV laser light.

FIGS. 6A and 6B illustrate alternative locations for the laser 18, as well as an alternative optical system 16 that employs a fiber optic delivery system. For example, it is anticipated that the laser may be remotely located from the opening 24, such as on the back of the oven (FIG. 6B) or mounted on the side of the oven (FIG. 6A). In these exemplary embodiments it may be useful to deliver the laser light from the remote laser to the area around the opening 24 via a fiber optic system 200.

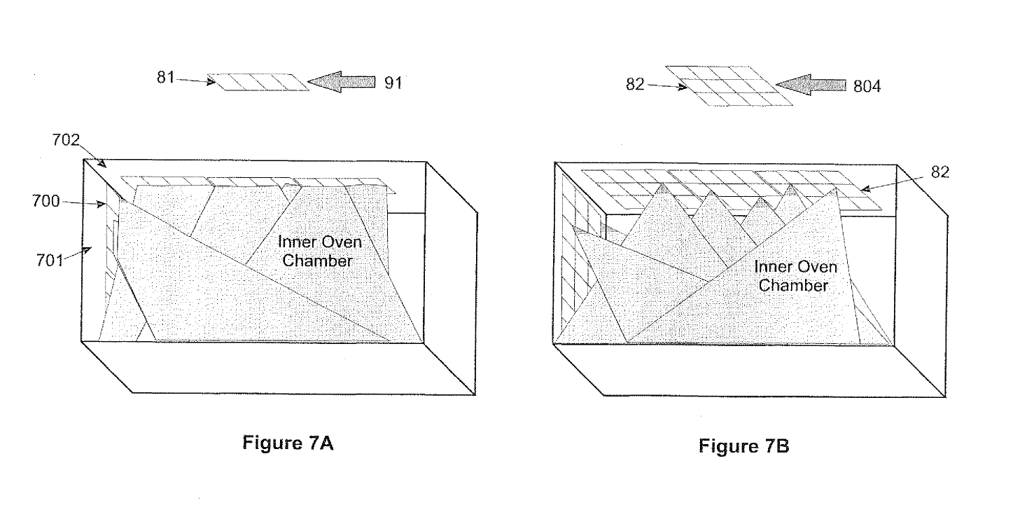

Turning now to FIGS. 7A and 7B, an alternative embodiment of the instant invention is illustrated. In this embodiment, a plurality of vertical cavity surface emitting lasers (VCSELs) or vertical light emitting diodes (VLEDs) 700 are employed to deliver UV light within the cooking chamber 12. In some embodiments of the instant invention it may be useful to combined the VCSELs and/or VLEDs with Fresnel Lenses. The VCSELs 700 are deployed on inner surfaces of the cooking chamber 12, such as on the top and side walls 702, 704. The VCSELs 700 may be deployed singularly, or arranged in strips or arrays to provide UV laser light over a substantial portion of the cooking chamber 12 with sufficient energy density to provide acceptable levels of sanitization within the cooking chamber 12. Additionally, the VCSEL's 700 may be arranged in arrays or panels that are oriented in slightly different directions such that substantial overlapping coverage of the cooking chamber is effected, as shown in FIG. 7B.

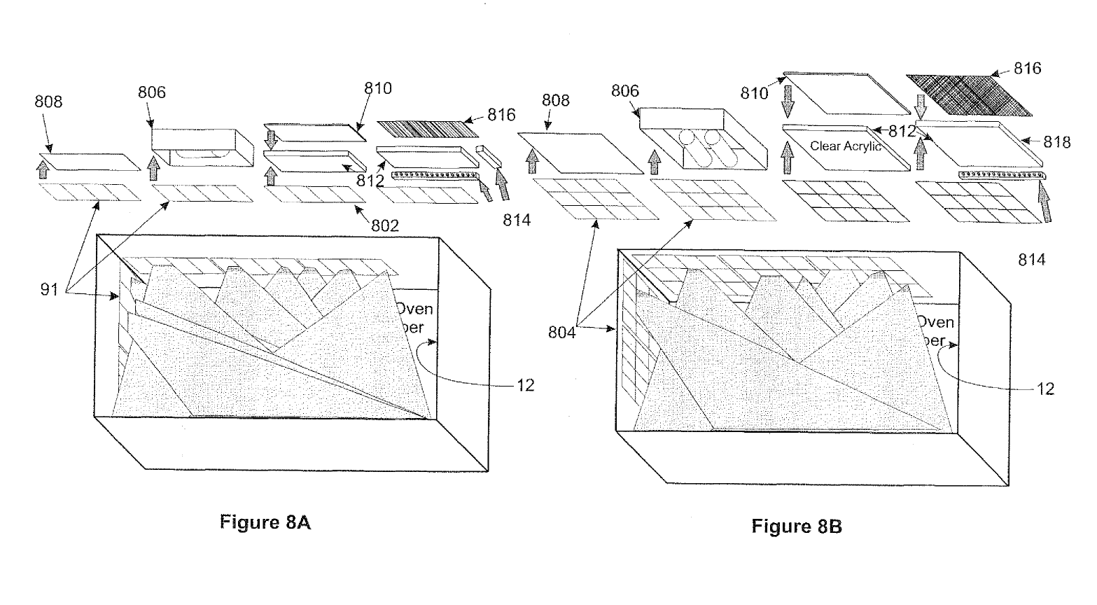

Turning now to FIGS. 8A and 8B, an alternative embodiment of the instant invention is illustrated in which Fresnel lenses 802, 804 or micro-lenses are disposed adjacent to various UV light sources. The Fresnel Lenses 802, 804 act to direct the UV light throughout the cooking chamber 12 at various angles and directions to provide substantial overlapping coverage. In the illustrated exemplary embodiments, Fresnel lens strips 802 or panels 804 are affixed to or otherwise constructed adjacent the top, back and/or side walls of the cooking chamber 12. The Fresnel lens strips 802 or panels 804 can be illuminated by a variety of UV light sources or methods. In one exemplary embodiment, conventional backlighting of the Fresnel lenses 802, 804 can be achieved by using UV lamps 806 contained in a reflective light fixture or housing located above or behind the Fresnel lenses 802, 804 within the cooking chamber 12. Those skilled in the art will appreciate that other UV lighting technology and solutions may be used in the alternative, such as phosphorous light strips (not shown), UV Electro-luminescent tape 808, VCSEL/VLED panels 810, or through backlighting by illumination of a clear substrate, such as acrylic 812 or glass (not shown) with sufficient thickness as to carry greater concentrations of UV light energy pumped in or projected into the substrate from the side by use of UV LED strips 814 or UV laser diode strips.

Each of these various embodiments of the backlit Fresnel lenses 802, 804, may be combined with a reflective mirrored backing 816 with or without the formation of angles on the reflective surface to control the direction of the UV light energy or to cause an increase in the angles of incidence. In addition, the Fresnel lenses 802, 804 may be illuminated by the use of a wafer panel or wafer strip with a plurality of vertical cavity surface emitting lasers combined with a micro lens array (not shown) as produced in a postage-stamp-sized chip containing hundreds of solid state micro-cavity lasers or UV VCSEL lasers, which may be grouped in series or in parallel to form UV laser strips or UV laser panels to project through the Fresnel lenses 802, 804 into the cooking chamber 12. The Fresnel lenses 802, 804 may be designed and installed for optimal UV light distribution with either a concentration to increase food penetration or for maximum distribution of the UV light to flood the food chamber 12 with UV light energy, to produce a positive or negative focus, and in some instances to produce both positive & negative focus from a single Fresnel lens, as is available through custom manufacturing of the Fresnel lens, to collimate the UV light and to cause divergence of the UV light energy within the cooking chamber 12 for substantial efficiency and effectiveness in the sanitizing process.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method for sanitizing a consumable product by exposing the product to ultraviolet light within a cooking appliance.

2. A method, as set forth in claim 1, wherein exposing the product to ultraviolet light further comprises producing ultraviolet light from a light source located outside of a cooking chamber that is adapted to receive the consumable product within the cooking appliance and directing the ultraviolet light into the cooking chamber.

3. A method, as set forth in claim 2, wherein producing ultraviolet light from a light source further comprises producing ultraviolet laser light from an ultraviolet laser.

4. A method, as set forth in claim 2, further comprising introducing microwave energy into the cooking chamber.

5. A method, as set forth in claim 4, wherein introducing microwave energy into the cooking chamber further comprises introducing microwave energy into the cooking chamber contemporaneous with directing ultraviolet light into the cooking chamber.

6. A method, as set forth in claim 4, wherein introducing microwave energy into the cooking chamber further comprises introducing microwave energy into the cooking chamber subsequent to directing ultraviolet light into the cooking chamber.

7. A method, as set forth in claim 2, wherein directing the ultraviolet light into the cooking chamber further comprises passing the ultraviolet light through an optical system that controllably directs the ultraviolet light within the cooking chamber.

8. A method, as set forth in claim 2, further comprising introducing ultraviolet light into the cooking chamber for a preselected duration of time.

9. A method, as set forth in claim 8, wherein the preselected duration of time is a function of the consumable product that is to be sanitized in the cooking chamber.

10. A method, as set forth in claim 8, further comprising measuring an intensity of the ultraviolet light within the cooking chamber, and adjusting the preselected duration of time as a function of the measured ultraviolet intensity.

11. A method, as set forth in claim 8, wherein the preselected duration of time is controllable based on information received from a user of the appliance.

12. A cooking appliance, comprising:
a microwave generator;
a cooking chamber capable of receiving microwave energy from the microwave generator;
an ultraviolet light source positioned outside the cooking chamber; and
an optical system configured to direct ultraviolet light from the ultraviolet light source into the cooking chamber.

13. A cooking appliance, as set forth in claim 12, wherein the ultraviolet light source comprises an ultraviolet laser.

14. A cooking appliance, as set forth in claim 12, wherein the ultraviolet light source comprises an ultraviolet laser diode.

15. A cooking appliance, as set forth in claim 12, wherein the ultraviolet light source comprises a vertical cavity surface emitting laser.

16. A cooking appliance, as set forth in claim 12, wherein the ultraviolet light source comprises a plurality of ultraviolet light sources.

17. A cooking appliance, as set forth in claim 16, wherein the plurality of ultraviolet light sources are oriented to introduce ultraviolet light into the cooking chamber in a preselected pattern.

18. A cooking appliance, as set forth in claim 12, further comprising a controller adapted to energize the microwave generator and deliver microwave energy into the cooking chamber contemporaneous with energizing the ultraviolet light source and directing ultraviolet light into the cooking chamber.

19. A cooking appliance, as set forth in claim 12, further comprising a controller adapted to energize the microwave generator and deliver microwave energy into the cooking chamber subsequent to energizing the ultraviolet light source and directing ultraviolet light into the cooking chamber.

20. A cooking appliance, as set forth in claim 12, wherein the optical system further comprises an expander adapted to alter the path of the ultraviolet light to expose a substantial portion of the cooking chamber to the ultraviolet light.

21. A cooking appliance, as set forth in claim 12, wherein the optical system further comprises a movable element for controllably redirecting the ultraviolet light through a preselected pattern within the cooking chamber.

22. A cooking appliance, as set forth in claim 12, wherein the cooking chamber has an interior surface adapted to reflect a substantial portion of the ultraviolet light directed therein by the optical system.

23. A cooking appliance, as set forth in claim 12, further comprising a controller adapted to introduce ultraviolet light into the cooking chamber for a preselected duration of time.

24. A method, as set forth in claim 12, wherein the controller is adapted to introduce ultraviolet light into the cooking chamber for a preselected duration of time that is a function of the consumable product that is to be sanitized in the cooking chamber.

25. A method, as set forth in claim 12, further comprising measuring an intensity of the ultraviolet light within the cooking chamber, and wherein the controller is adapted to introduce ultraviolet light into the cooking chamber for a preselected duration of time that is a function of the measured ultraviolet intensity.

26. A method, as set forth in claim 12, wherein the controller is adapted to introduce ultraviolet light into the cooking chamber for a preselected duration of time that is based on information received from a user of the appliance.
